(19) United States
(12) Patent Application Publication
(10) Pub. No.: US 2015/0101983 A1
(43) Pub. Date: Apr. 16, 2015

(54) REAL TIME SELF-STERILIZING COMPOSITE WATER FILTER AND SYSTEM FOR SAME

(71) Applicant: Synder Filtration, Vacaville, CA (US)

(72) Inventors: Edward Yeh, Fairfield, CA (US); Joseph Wang, Fairfield, CA (US); Yongming Zhang, Taizhou City (CN)

(21) Appl. No.: 14/510,988

(22) Filed: Oct. 9, 2014

Related U.S. Application Data
(60) Provisional application No. 61/927,773, filed on Jan. 15, 2014.

(30) Foreign Application Priority Data
Oct. 12, 2013 (CN) 201320628903.5

(51) Int. Cl. B01D 65/02; C02F 1/44; C02F 1/32; B01D 69/12

(52) U.S. Cl. CPC B01D 65/022; B01D 69/12; C02F 1/441; C02F 1/442; C02F 1/444; C02F 1/325; B01D 2321/343; C02F 2201/3223; C02F 2303/04; C02F 2303/16
USPC 210/636; 210/321.69

(57) ABSTRACT

The present invention discloses a water filter device comprised of a housing, a first cap, a membrane element, a permeate tube, a quartz sleeve and a UV lamp. The permeate tube may be designed with a plurality of uniformly-distributed permeate openings. The membrane element is disposed outside of the permeate tube. The membrane element, the permeate tube, the quartz sleeve and the UV lamp may be disposed in one housing. The quartz sleeve is disposed along the central axis of the permeate tube while the UV lamp is disposed inside or within the quartz sleeve.

### CROSS-REFERENCE TO RELATED APPLICATIONS

The present invention and application relates to, and claims the benefit of the earlier filing date and priority of U.S. Patent Application No. 61/927,773, filed on Jan. 15, 2014 and Chinese Patent Application No. 201320628903.5 filed on Oct. 12, 2013.

### FIELD OF THE INVENTION

The present invention relates to the apparatus and system for the purification of liquids using a real time self-sterilizing composite water filter.

### BACKGROUND OF THE INVENTION

Currently, the types of traditional filters available in the market are polypropylene (“PP”) cotton filter, carbon filter, ultrafiltration (“UF”) membrane filter, nanofiltration (“NF”) membrane filter and reverse osmosis (“RO”) membrane filter. During the use of these filter elements and others, there is a chance for bacterial or other microbe growth to occur within the element, particularly inside a permeate tube, the filter or other like structure. In the present application, a microbe refers collectively to microscopic organisms, including, but not limited to, bacteria, fungi, mycoplasma, protozoa, viruses and other like organisms that may be sensitive to ultraviolet (“UV”) irradiation. The raw water feed often contains an unacceptably high level of microbes such as bacteria and may sometimes reach levels above pre-determined safety levels. Since the PP cotton and carbon filters have relatively large pores, bacteria and other microbes will pass through these filters. With the possibility of bacterial growth inside the filter, the water filter and the water can potentially become contaminated by the microbes and/or their microbial byproducts as a secondary contamination to those present in the raw water. As far as the traditional UF, NF or RO filters, the filter itself may have a pore size smaller than bacteria and other microbes, therefore, the microbes may be theoretically retained by the filters. However, the retained microbes may still accumulate inside the membrane and permeate chamber and continue to replicate. The accumulated microbes and the products from microbial metabolism could cause undesired odor and negatively impact the final water quality.

An embodiment of this filter device and system is directed to substantially solving the problem of bacterial, or other microbe, growth and contamination present in traditional filters. Embodiments of the present invention are directed to the purification of water, but one of ordinary skill in the art would realize that many other liquids and/or fluids may be used in conjunction with the present device and system, as such, the use of the term “water” in the present application is merely exemplary in nature.

### SUMMARY OF THE INVENTION

An embodiment of the present invention is a real-time, self-sterilizing composite water filter device and system. In one embodiment, water passing through the water filter device and system is immediately filtered as the living microbes and their spores are either substantially removed from the water by a membrane or are neutralized by UV irradiation, rendering the filtered water drinkable. A membrane may include one or more of any type of filter—including traditional UF, NF and RO membrane filters—capable of removing microbes from the water being filtered. In this embodiment, the UV lamp may be integrated into the device such that any microbes or spores that are caught by or pass through the membrane filter may be neutralized by UV light.

An embodiment of the present invention comprises a sterilizing composite filter device comprising a housing, a raw water inlet, a membrane filter element, a permeate tube having a first and second plurality of openings, a permeate flow channel, a quartz sleeve, a UV lamp and a permeate water outlet. In an embodiment the UV lamp is disposed within the quartz sleeve along a central axis of the device, the quartz sleeve is disposed along the central axis of the permeate tube, the permeate water flow channel is disposed between an exterior surface of the quartz sleeve and an interior surface of the permeate tube, an interior surface of the membrane filter element is disposed around an exterior surface of the permeate tube, the first plurality of openings are in communication with the interior surface of the membrane filter element and the second plurality of openings are in communication with the permeate flow channel, the permeate water outlet is in fluid communication with the permeate flow channel, and wherein the raw water inlet, membrane filter element, permeate tube, permeate flow channel, quartz sleeve, UV lamp and the permeate water outlet are disposed within the housing.

The membrane filter element may be any type of membrane filter, including a spiral membrane filter, tubular membrane filter, hollow fiber membrane filter, or plate-and-frame membrane filter.

In various embodiments the membrane filter element may be comprised of two or more filter elements. The membrane filter element may be comprised of at least one of an ultrafiltration, nanofiltration and reverse osmosis membrane filter. In an embodiment the membrane filter element may be comprised of at least two of an ultrafiltration, nanofiltration and reverse osmosis membrane filter. The first plurality of openings and second plurality of openings may be aligned or not aligned. The first plurality of openings may be equal or not equal in number to the second plurality of openings. The first plurality and/or second plurality of openings may or may not be uniformly distributed.

In an embodiment the sterilizing composite filter device may comprise an intermediate seal disposed between an exterior surface of the quartz sleeve and an interior surface of the permeate tube. In various embodiments the wavelength of the UV lamp may be between about 100 nm and about 400 nm, between about 100 nm and about 280 nm, between about 250 nm and about 260 nm. In an embodiment the wavelength of the UV lamp may be about 254 nm.

In an embodiment an interior portion of the membrane filter element may be sterilized by UV irradiation emitted by the UV lamp. In an embodiment the second plurality of openings may not extend beyond the length of the UV lamp. An embodiment comprises a feed water outlet permitting a portion of the water to flow from the water inlet through the membrane filter element and to exit the device without flowing through the permeate tube. In an embodiment the raw water inlet is disposed in a first cap. In an embodiment the permeate water outlet and the feed water outlet are disposed in a second cap. In an embodiment of the present invention, the first cap may be a top cap, and the second cap may be a bottom cap. In an embodiment the device comprises an electronic control device connected to the UV lamp.

An embodiment of the present invention is a sterilizing composite filter device comprising a housing, a raw water inlet, a membrane filter element, a permeate tube having a first and second plurality of openings, a permeate flow channel, an intermediate seal, a quartz sleeve, a UV lamp, and a permeate water outlet, wherein the UV lamp is disposed within the quartz sleeve along a central axis of the device, the quartz sleeve is disposed along the central axis of the permeate tube, the intermediate seal is disposed between an exterior surface of the quartz sleeve and an interior surface of the permeate tube, the permeate water flow channel is disposed between an exterior surface of the quartz sleeve and an interior surface of the permeate tube positioned below the intermediate seal, an interior surface of the membrane filter element is disposed around an exterior surface of the permeate tube, the first plurality of openings are in communication with the interior surface of the membrane filter element and the second plurality of openings are in communication with the permeate flow channel, the permeate water outlet is in fluid communication with the permeate flow channel, and wherein the raw water inlet, membrane filter element, permeate tube, permeate flow channel, intermediate seal, quartz sleeve, UV lamp and the permeate water outlet are disposed within the housing.

An embodiment of the present invention is a sterilizing composite filter device comprising a housing, a raw water inlet, a membrane filter element, a permeate tube having a first and second plurality of openings, a permeate flow channel, a quartz sleeve, a UV lamp, a permeate water outlet, and a feed water outlet, wherein the UV lamp is disposed within the quartz sleeve along a central axis of the device, the quartz sleeve is disposed along the central axis of the permeate tube, the permeate water flow channel is disposed between an exterior surface of the quartz sleeve and an interior surface of the permeate tube, an interior surface of the membrane filter element is disposed around an exterior surface of the permeate tube, the first plurality of openings are in communication with the interior surface of the membrane filter element and the second plurality of openings are in communication with the permeate flow channel, the permeate water outlet is in fluid communication with the permeate flow channel, the feed water outlet is in fluid communication with the membrane filter element permitting a portion of the water to flow from the water inlet through the membrane filter element and to exit the device without flowing through the permeate tube, wherein the raw water inlet, membrane filter element, permeate tube, permeate flow channel, quartz sleeve, UV lamp, the permeate water outlet and feed water outlet are disposed within the housing.

An embodiment of the present invention is a method of filtering water using the device disclosed herein. An embodiment of the present invention is a system for filtering water comprising the device disclosed herein. An embodiment of the present invention is a system for filtering water comprising a pre-filter disposed upstream from the membrane filter element.

In an embodiment, a spiral membrane filter element uses a permeate tube, wherein the permeate flows inside of the element spiraling from an outer area to the central permeate tube and enters the tube through a series of openings disposed in fluid connection with the membrane filter element. In one embodiment, these openings may be uniformly distributed across the length of the tube. By way of example only, the openings may be set approximately one half-inch apart along a tube that extends approximately one foot. In a preferred embodiment, the openings in the permeate tube are distributed to allow permeate water to flow into the tube evenly so as to maximize the flow-rate of the permeate water into the tube. In one embodiment, this may be accomplished by distributing the openings uniformly along the length of the tube. In a preferred embodiment, the openings are of a select size to prevent a bottle-neck or restriction of water flow at one or more points. In one embodiment, this is accomplished by an opening size such that the sum of all opening areas is approximately equal to the cross-sectional area of the permeate tube. In a preferred embodiment, the opening size and cross-sectional area of the permeate tube should be high enough that no pressure is built up inside the element when permeate water is flowing out of the element. By way of example only, an embodiment may include openings that are approximately one quarter-inch in diameter and approximately one half-inch apart and are situated along the tube in two parallel lines. In a preferred embodiment, the tube itself should be made of a material capable of meeting sanitary standards, such as polysulfone, or other material that does not release harmful or undesirable chemicals into the water being filtered.

An embodiment of the present invention may comprise an intermediate seal disposed between an interior surface of the permeate tube and an exterior surface of the quartz sleeve. The intermediate seal should be made of a material capable of meeting sanitary standards that does not release or leak harmful or undesirable chemicals into the water being filtered beyond acceptable levels. Embodiments may use intermediate seals made of silicon rubber, natural rubber or synthetic rubber, such as ethylene propylene diene monomer (M-class) rubber, or any other suitable material. An embodiment of the present invention may comprise an O-ring disposed around the circumference of a top portion of the permeate tube.

An embodiment of the present invention may comprise an electronic control device connected by at least one socket wire to the UV lamp. In one embodiment, the UV lamp can connect wirelessly to the control device.

An embodiment of the present invention may comprise a method of filtering water using the device or system. Still other embodiments may be directed to a method of filtering other liquids and/or fluids, such as alcohol, alcohol-water mixtures, urine, or organic liquids, including, but not limited to, edible or motor oils and the like. An embodiment of the present invention may comprise a system comprising the device.

In an embodiment of the present invention, a filter device is comprised of a housing, a first cap, at least one membrane element, and a permeate tube. The filter device may be used for filtering water or optimized for filtration of non-water solutions. The permeate tube may comprise a first plurality of permeate openings which may or may not be substantially uniformly-distributed in communication with the membrane element. The membrane element is disposed around the circumference of the permeate tube. For the purposes of this application circumference is defined as the exterior edge of a closed curve or circular object, rather than to the length of the edge. Both the membrane element and the permeate tube are disposed in one housing. At least one unique feature of an embodiment of the present invention relates to the presence of a filter element, a quartz sleeve and a UV lamp incorporated in a single housing. The terms “UV lamp” and “UV light” are used interchangeably in the present application and generally refer to ultraviolet light generated by a lamp.

The quartz sleeve may be disposed along the central axis of the permeate tube while the UV lamp is disposed within the quartz sleeve. An embodiment the self-sterilizing composite water filter device and system according to the present invention may comprise an intermediate seal that connects, or is disposed at a junction of, the quartz sleeve with the permeate tube. In an embodiment the intermediate seal may be made of silicone or any other suitable material. A top portion of the permeate tube may comprise an O-ring disposed in a groove disposed in the top portion of the permeate tube. In an embodiment the first cap may comprise an electric control device connected to the UV lamp via at least one socket wire, a wireless connection, a USB connection, or other suitable connection.

### BRIEF DESCRIPTION OF THE DRAWINGS

FIG. 1 is a cross-sectional schematic diagram with the first and second cap removed according to an embodiment of the present invention.

FIG. 2 is a cross-sectional schematic diagram with the first and second cap in place according to an embodiment of the present invention.

### DETAILED DESCRIPTION

One embodiment of the present invention is directed to overcome the shortcomings of traditional filter systems. The real-time, self-sterilizing composite water filter and system is intended to substantially remove, breakdown or neutralize certain impurities, including microbes and undesired chemical compounds, from raw water and substantially disinfect a portion of the filter element or membrane as well as the filtered permeate water exiting the device or system before consumption by the end user. UV light may neutralize substantially all escaped microbes, which may otherwise be removed by the membrane. It serves as a secondary protection from microbial contamination. The device, method and system according to embodiments of the present invention may also be used to process liquids other than water, including, but not limited to, alcohol, alcohol-water mixtures, urine, or organic liquids, including, but not limited to, edible or motor oils and the like. In the present application water is used throughout to describe embodiments of the present invention, but this is by example only, and is by no means limiting to the use of water as the liquid.

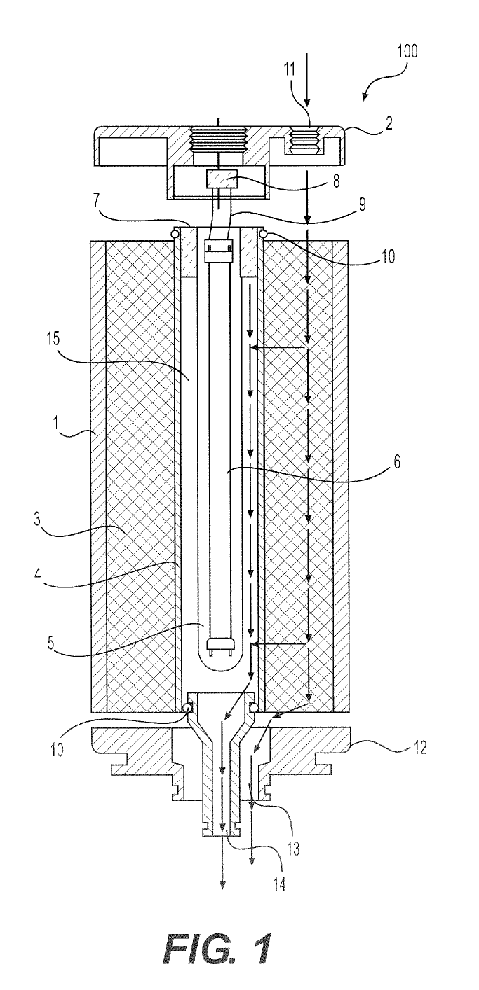

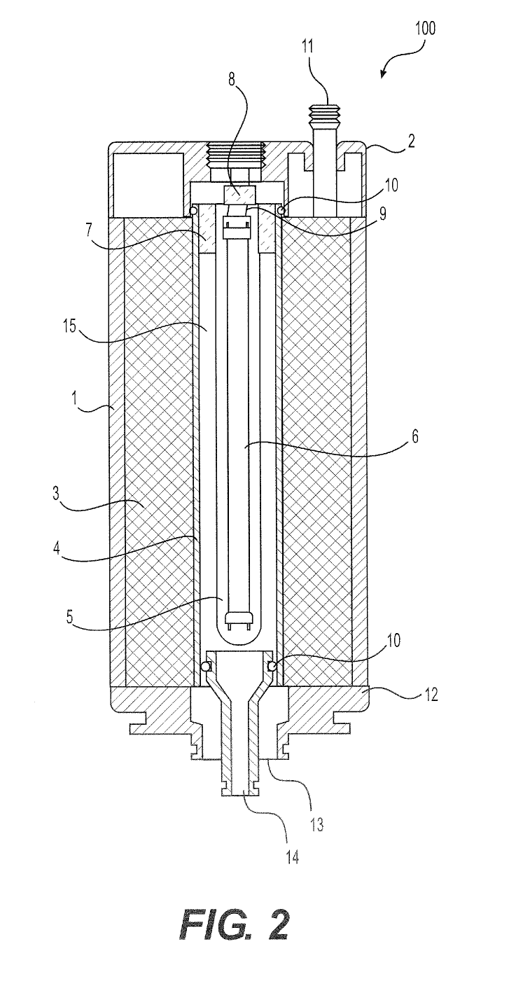

FIGS. 1 and 2 are schematic diagrams of the self-sterilizing composite filter device 100 and system according to an embodiment of the present invention. The device 100 and system according to an embodiment of the invention comprises housing 1, raw water inlet 11, first cap 2, at least one membrane filter element 3, permeate tube 4, quartz sleeve 5, UV lamp 6 and permeate water outlet 14. An embodiment may also comprise intermediate seal 7, electric control device 8, socket wire 9 and O-ring 10. In one embodiment, a valve, pump or like device (not shown) may be used to regulate the flow of water through the device or system. An embodiment of the device or system may comprise a ballast (not shown) to regulate electrical current flow to UV lamp 6. In a preferred embodiment, any portion of the filter device that comes into contact with water may be made of a sanitary-grade material, substantially reducing any amount of undesirable chemicals released into the water.

A permeate tube 4 may comprise a first plurality of permeate openings in fluid communication with membrane filter element 3 and a second plurality of openings in fluid communication with permeate flow channel 15. Permeate tube 4 may be incorporated as a part of membrane filter element 3, or may be a stand-alone unit. Permeate flow channel 15 is disposed between an interior surface of permeate tube 4 and an exterior surface of quartz sleeve 5. For the purposes of this application, interior and exterior surfaces are with respect to the center axis of the device. The first plurality of openings may or may not be aligned with, or be equal in number and/or size to, the second plurality of openings. The permeate openings may or may not be substantially uniformly-distributed. The flexibility of the arrangement, number and size of the first and second plurality of openings permits the regulation of the flow of water through the device. At least one membrane filter element 3 is disposed outside of and surrounding the exterior surface of permeate tube 4. Membrane element 3 may comprise a single filter material and/or medium, or be comprised of more than one material and/or medium combined within membrane filter element 3. The at least one filter material and/or medium may be comprised of suitable materials and/or membranes know to one of ordinary skill in the art. In one embodiment, a pre-filter comprising PP and/or carbon may be employed to remove large particles, such as rust, to prevent the membrane filter 3 from fouling. In this embodiment, water passes through the pre-filter and is then filtered by membrane filter element 3.

Both membrane filter element 3 and permeate tube 4 are disposed in single housing 1. At least one unique feature of the filter device 100 and system according to an embodiment of the present invention is related to the incorporation of membrane filter element 3, quartz sleeve 5 and UV lamp 6 in single housing 1. In this embodiment, quartz sleeve 5 is disposed along the central axis of permeate tube 4 while the UV lamp 6 is disposed inside or within quartz sleeve 5. Permeate flow channel 15 is disposed between permeate tube 4 and quartz sleeve 5. Water enters the device through raw water inlet 11 and flows through membrane filter element 3, a portion of the water flows through permeate tube 4 and into permeate flow channel 15, subsequently exiting through permeate outlet 14. Water not passing through permeate tube 4 flows through membrane filter element 3 and subsequently exits through water outlet 13 as non-permeate water. In one embodiment, UV lamp 6 and quartz sleeve 5 may be placed outside filter element 3 in a separate chamber (not shown), such that water flows out of membrane filter element 3 through water outlet 13 and/or permeate outlet 14 and into a UV lamp chamber.

In an embodiment the self-sterilizing composite water filter device 100 and system comprises intermediate seal 7 that contacts a top exterior portion of quartz sleeve 5 with a top interior portion of permeate tube 4. In an embodiment intermediate seal 7 may be made of silicone or any other suitable material. In an embodiment, first cap 2 comprises an electric control device 8 that is wired to UV lamp 6 and controls the power applied to the UV lamp 6.

The wavelength of the UV lamp is selected to substantially inhibit at least one of virus, bacteria, microbe and pathogenic growth in the water during filtration, and may be of a wavelength to degrade chemical bonds within certain compounds. The wavelength according to different embodiments may be in the range of about 100 nm to about 400 nm, about 100 nm to about 280 nm, about 250 nm to about 260 nm and, in one embodiment, about 254 nm. At the appropriate wavelength one embodiment of the device and system according to the present invention substantially prevents the growth of bacteria with a disinfection efficiency of about 80%, about 90% or about 99.9% or more. In an embodiment UV lamp 6 may be of a sufficient wavelength and/or intensity to not only disinfect, but to remove chlorine and chloramine species from the raw water through, for example, photolysis. In an example of one embodiment, molecules are broken down into smaller units through the absorption of light. Photolysis may also be known as photo dissociation or photodecomposition, a chemical reaction in which a chemical compound is broken down by photons. In an embodiment UV irradiation may be used to oxidize and destroy trace chemical contaminants in the water.

Due to the design of one embodiment utilizing UV lamp 6, the permeate water and a portion of membrane filter element 3 and permeate tube 4 will be subject to UV irradiation during filtration. The water passing through the device in this embodiment will have a substantial amount of impurities removed as well as be further disinfected. The device according to one embodiment of the present invention is easier to operate, saves space, simplifies construction, and most importantly, produces cleaner and safer water.

In conjunction with the drawings, the following examples illustrate an embodiment of the present invention with further description.

### EXAMPLE

Referring to FIGS. 1 and 2, an embodiment of the present invention is a real-time self-sterilizing composite water filter device 100 and system comprising housing 1, raw water inlet 11, first cap 2, at least one membrane filter element 3, permeate tube 4, quartz sleeve 5, UV lamp 6, water outlet 13 and permeate water outlet 14. Membrane element 3, permeate tube 4, quartz sleeve 5 and UV lamp 6 are disposed in housing 1, in a single filter unit. Membrane element 3 is disposed around and in communication with an exterior surface of permeate tube 4. An interior surface of permeate tube 4 is in communication with permeate flow channel 15 which, in turn, is disposed around the exterior surface of quartz sleeve 5. Permeate tube 4 comprises a first plurality of permeate openings, of any suitable shape, that may or may not be substantially uniformly-distributed. Permeate tube 4 also comprises a second plurality of permeate openings that may be of any suitable shape and may or may not be uniformly distributed and may or may not be aligned with, or be equal in number and/or size to, the first plurality of openings. The first plurality of openings are disposed on the exterior surface of permeate tube 4 and in fluid communication with the interior surface of membrane filter element 3 and permeate tube 4. The second plurality of openings are disposed on the interior surface of permeate tube 4 and are in fluid communication with permeate flow channel 15 and permeate tube 4. Quartz sleeve 5 is disposed along the central axis of permeate flow channel 15 and permeate tube 4 while UV lamp 6 is disposed inside quartz sleeve 5. Permeate flow channel 15 is disposed to an exterior surface of quartz sleeve 5 and an interior surface of permeate tube 4. UV lamp 6 has a substantially similar length as permeate tube 4, or otherwise designed such that the permeate water passing through permeate tube 4 is sufficiently exposed to UV irradiation. Therefore, substantially all the permeate water during and immediately after filtration will receive sufficient UV irradiation to substantially neutralize microbes such as bacteria and substantially disinfect the water, as well as, to some degree, break down certain chemical compounds.

Intermediate seal 7 is used to connect the exterior surface of quartz sleeve 5 to the interior surface of permeate tube 4 in a portion of permeate tube 4 disposed near first cap 2. Seal 7 may be made of silicon or any other suitable material. Seal 7 may also function to provide support to quartz sleeve 5 and in turn UV lamp 6. O-ring 10 is disposed on a portion of, and around the exterior surface of permeate tube 4. O-ring 10 connects an interior surface of first cap 2 with an exterior surface of permeate tube 4.

First cap 2 may comprise electric control device 8 wired by at least one socket wire 9 to UV lamp 6. Electric control device 8 disposed inside first cap 2 may use a single power plug to operate. In an alternative embodiment, control device 8 may be disposed on an exterior surface of first cap 2, or not physically attached to first cap 2. Control device 8 may be used to regulate or adjust the intensity of the UV lamp and/or the duration that the UV lamp is on and/or off.

Water enters the device through raw water inlet 11 and is filtered initially by membrane filter element 3. A portion of the water seeps into and through permeate tube 4, and is substantially disinfected through exposure to irradiation provided by UV lamp 6 on or before entering water flow channel 15. Water exiting permeate tube 4 and into water flow channel 15 is now known as permeate water. Permeate water subsequently flows out of the device through permeate water outlet 14. The portion of water not flowing through permeate tube 4 exits device 100 via water outlet 13. Not only is permeate tube 4 and to an extent the innermost portion of membrane filter element 3 substantially sterilized by exposure to the UV irradiation emitted from lamp 6, but the permeate water has been further disinfected without spending extra time flowing through the device. Known systems require a UV lamp that is mounted externally from housing 1 resulting in a larger footprint, increased expense and a more complicated set-up. The final output of permeate water passing through the entire device exits via permeate water outlet 14 and will have substantial amounts of impurities removed and be further disinfected than accomplished from filtration alone, without the need to pass through an additional structure or device. Additional novel characteristics of an embodiment of the present invention are at least economies in space in having a smaller footprint, is simpler to construct, easier to operate and provides a higher quality filtered water compared to known devices.

The embodiment above is only to illustrate the utility of new technical ideas and characteristics, and its purpose is to allow a person become familiar with the technology with an understanding of the content of the technology and thus being able to implement it. It's not intended to limit the scope of protection of the utility model. Wherever there are changes or modifications made to the equivalent of the new practical model, it should be covered in the utility model protection range.

1. A sterilizing composite filter device comprising:
a housing;
a raw water inlet;
a membrane filter element;
a permeate tube having a first and second plurality of openings;
a permeate flow channel;
a quartz sleeve;
a UV lamp; and
a permeate water outlet;
wherein the UV lamp is disposed within the quartz sleeve along a central axis of the device;
the quartz sleeve is disposed along the central axis of the permeate tube;
the permeate water flow channel is disposed between an exterior surface of the quartz sleeve and an interior surface of the permeate tube;
an interior surface of the membrane filter element is disposed around an exterior surface of the permeate tube;
the first plurality of openings are in communication with the interior surface of the membrane filter element and the second plurality of openings are in communication with the permeate flow channel;
the permeate water outlet is in fluid communication with the permeate flow channel; and
wherein the raw water inlet, membrane filter element, permeate tube, permeate flow channel, quartz sleeve, UV lamp and the permeate water outlet are disposed within the housing.

2. The sterilizing composite filter device of claim 1 wherein the membrane filter element is comprised of two or more filter elements.

3. The sterilizing composite filter device of claim 1 wherein the membrane filter element is comprised of at least one of an ultrafiltration, nanofiltration and reverse osmosis membrane filter.

4. The sterilizing composite filter device of claim 1 wherein the membrane filter element is comprised of at least two of an ultrafiltration, nanofiltration and reverse osmosis membrane filter.

5. The sterilizing composite filter device of claim 1 wherein the first plurality of openings and second plurality of openings are aligned.

6. The sterilizing composite filter device of claim 1 wherein the first plurality of openings and second plurality of openings are not aligned.

7. The sterilizing composite filter device of claim 1 wherein the first plurality of openings are equal in number to the second plurality of openings.

8. The sterilizing composite filter device of claim 1 wherein the first plurality of openings are not equal in number to the second plurality of openings.

9. The sterilizing composite filter device of claim 1 wherein the first plurality of openings are uniformly distributed.

10. The sterilizing composite filter device of claim 1 wherein the first plurality of openings are not uniformly distributed.

11. The sterilizing composite filter device of claim 1 wherein the second plurality of openings are uniformly distributed.

12. The sterilizing composite filter device of claim 1 wherein the second plurality of openings are not uniformly distributed.

13. The sterilizing composite filter device of claim 1 comprising an intermediate seal disposed between an exterior surface of the quartz sleeve and an interior surface of the permeate tube.

14. The sterilizing composite filter device of claim 1 wherein the wavelength of the UV lamp is between about 100 nm and about 400 nm.

15. The sterilizing composite filter device of claim 1 wherein the wavelength of the UV lamp is between about 100 nm and about 280 nm.

16. The sterilizing composite filter device of claim 1 wherein the wavelength of the UV lamp is between about 250 nm and about 260 nm.

17. The sterilizing composite filter device of claim 1 wherein the wavelength of the UV lamp is about 254 nm.

18. The sterilizing composite filter device of claim 1 wherein an interior portion of the membrane filter element is sterilized by UV irradiation emitted by the UV lamp.

19. The sterilizing composite filter device of claim 1 wherein the second plurality of openings do not extend beyond the length of the UV lamp.

20. The sterilizing composite filter device of claim 1 comprising a feed water outlet permitting a portion of the water to flow from the water inlet through the membrane filter element and to exit the device without flowing through the permeate tube.

21. The sterilizing composite filter device of claim 1 wherein the raw water inlet is disposed in a first cap.

22. The sterilizing composite filter device of claim 1 wherein the permeate water outlet and the feed water outlet are disposed in a second cap.

23. The sterilizing composite filter device of claim 1 comprising an electronic control device connected to the UV lamp.

24. A sterilizing composite filter device comprising:
a housing;
a raw water inlet;
a membrane filter element;
a permeate tube having a first and second plurality of openings;
a permeate flow channel;
an intermediate seal;
a quartz sleeve;
a UV lamp; and
a permeate water outlet;
wherein the UV lamp is disposed within the quartz sleeve along a central axis of the device;
the quartz sleeve is disposed along the central axis of the permeate tube;
the intermediate seal is disposed between an exterior surface of the quartz sleeve and an interior surface of the permeate tube;
the permeate water flow channel is disposed between an exterior surface of the quartz sleeve and an interior surface of the permeate tube positioned below the intermediate seal;
an interior surface of the membrane filter element is disposed around an exterior surface of the permeate tube;
the first plurality of openings are in communication with the interior surface of the membrane filter element and the second plurality of openings are in communication with the permeate flow channel;
the permeate water outlet is in fluid communication with the permeate flow channel; and
wherein the raw water inlet, membrane filter element, permeate tube, permeate flow channel, intermediate seal, quartz sleeve, UV lamp and the permeate water outlet are disposed within the housing.

25. A sterilizing composite filter device comprising:
a housing;
a raw water inlet;
a membrane filter element;
a permeate tube having a first and second plurality of openings;
a permeate flow channel;
a quartz sleeve;
a UV lamp;
a permeate water outlet; and
a feed water outlet;
wherein the UV lamp is disposed within the quartz sleeve along a central axis of the device;
the quartz sleeve is disposed along the central axis of the permeate tube;
the permeate water flow channel is disposed between an exterior surface of the quartz sleeve and an interior surface of the permeate tube;
an interior surface of the membrane filter element is disposed around an exterior surface of the permeate tube;
the first plurality of openings are in communication with the interior surface of the membrane filter element and the second plurality of openings are in communication with the permeate flow channel;
the permeate water outlet is in fluid communication with the permeate flow channel;
the feed water outlet is in fluid communication with the membrane filter element permitting a portion of the water to flow from the water inlet through the membrane filter element and to exit the device without flowing through the permeate tube;
wherein the raw water inlet, membrane filter element, permeate tube, permeate flow channel, quartz sleeve, UV lamp, the permeate water outlet and feed water outlet are disposed within the housing.

26. A method of filtering water using the device of claim 1.

27. A system for filtering water comprising the device of claim 1.

28. The system of claim 25 comprising a pre-filter disposed upstream from the membrane filter element.
